(19) United States
(12) Patent Application Publication
(10) Pub. No.: US 2011/0243664 A1
(43) Pub. Date: Oct. 6, 2011

(54) POND AND METHOD OF MAKING SAME

(76) Inventor: James P. Sullivan, Framingham, MA (US)

(21) Appl. No.: 13/074,091

(22) Filed: Mar. 29, 2011

Related U.S. Application Data
(60) Provisional application No. 61/320,151, filed on Apr. 1, 2010.

(51) Int. Cl. B65G 5/00

(52) U.S. Cl. 405/53

(57) ABSTRACT

A pond is constructed using expanded foam core wall elements, situated on a Geo-technical fabric and having a leakproof liner. The expanded foam core wall elements define the size and shape of the pond. The expanded foam core wall elements are restrained from moving by any of tie rods and fasteners, stakes, and earthen fill and combinations of such restraints. The pond can be constructed quickly and inexpensively, and when no longer needed, can be disassembled and removed quickly and inexpensively without generating environmental waste. Uses of such ponds can include recreation, hydroponic aquaculture, and renewable energy uses such as solar thermal energy generation.

### CROSS-REFERENCE TO RELATED APPLICATIONS

This application claims priority to and the benefit of co-pending U.S. provisional patent application Ser. No. 61/320,151 filed Apr. 1, 2010 which application is incorporated herein by reference in its entirety.

### FIELD OF THE INVENTION

The invention relates to systems and methods for constructing ponds in general and particularly to systems and methods of constructing ponds that employ environmentally friendly methods and materials.

### BACKGROUND OF THE INVENTION

It is known in the prior art to construct ponds by digging an opening in the earth and lining the opening with materials such as concrete, gunnite, and other materials that one can expect to be permanent, or of long duration. Such construction methods are expensive and time consuming.

When the pond is no longer needed, removal of the pond is expensive and often involves the production of waste materials that have to be removed and sent to a disposal facility. The site of the pond then needs to be remediated, at additional expense and cost in time.

There is a need for systems and methods of making ponds or other small bodies of water that employ environmentally-friendly materials and methods and that allow removal of the pond easily and that require minimal remediation when the need for the pond no longer exists.

### SUMMARY OF THE INVENTION

According to one aspect, the invention features a method of fabricating a pond. The method comprising the steps of: installing a first Geo-technical fabric having an area, a periphery and a surface at a location where a pond is being constructed; installing a plurality of segments of expanded foam core in respective positions with regard to one another, the plurality of segments of expanded foam core comprising a wall that defines a periphery of the pond, a size of the pond and a shape of the pond, a bottom surface of each of the plurality of segments of expanded foam core resting on the surface of the first Geo-technical fabric; wrapping the periphery of the first Geo-technical fabric over and around an exterior surface of the plurality of segments of expanded foam core and down an inside surface of the periphery of the pond defined by the plurality of segments of expanded foam core; providing a restraint that is configured to maintain each of the plurality of segments of expanded foam core in the respective positions; and installing a leakproof liner inside the pond to provide a volume that holds a liquid.

In one embodiment, the method further comprises the step of filling the pond with the liquid.

In another embodiment, the method further comprises the step of, prior to the step of installing the first Geo-technical fabric, preparing the location where the pond is to be constructed.

In yet another embodiment, the method further comprises the step of shaping the bottom surface of at least one of the plurality of segments of expanded foam core to correct for grade.

In still another embodiment, the step of providing a restraint comprises providing tie rods and fasteners to maintain at least one of the plurality of segments of expanded foam core in its respective position.

In a further embodiment, the step of providing a restraint comprises providing fill material to maintain at least one of the plurality of segments of expanded foam core in its respective position.

In yet a further embodiment, the step of providing a restraint comprises placing the bottom surface of at least one of the plurality of segments of expanded foam core in a trench to maintain the at least one of the plurality of segments of expanded foam core in its respective position.

In an additional embodiment, the method further comprises the step of arranging material to define a grade of a bottom of the pond prior to installing the leakproof liner.

In one more embodiment, the method further comprises the step of installing a layer of Geo-technical fabric over the bottom of the pond prior to installing the leakproof liner.

In still a further embodiment, the layer of Geo-technical fabric is part of the first Geo-technical fabric.

In yet a further embodiment, the layer of Geo-technical fabric is not part of the first Geo-technical fabric.

In an additional embodiment, the leakproof liner is anchored to a wall of the pond.

In one more embodiment, the method further comprises the step of providing one or more additional structural features.

According to another aspect, the invention relates to a pond. The pond comprises a first Geo-technical fabric having an area, a periphery and a surface situated at a location; a plurality of segments of expanded foam core in respective positions with regard to one another, the plurality of segments of expanded foam core comprising a wall that defines a periphery of the pond, a size of the pond and a shape of the pond, a bottom surface of each of the plurality of segments of expanded foam core resting on the surface of the first Geo-technical fabric, the periphery of the first Geo-technical fabric overlayed about an exterior surface of the plurality of segments of expanded foam core and placed down an inside surface of the periphery of the pond defined by the plurality of segments of expanded foam core; a restraint that is configured to maintain each of the plurality of segments of expanded foam core in the respective positions; and a leakproof liner inside the pond to provide a volume that holds a liquid; the pond configured to be disassembled and removed from the location when no longer required, the disassembly and removal capable of being performed in an environmentally-friendly manner.

In one embodiment, the restraint is a tie rod and at least one fastener.

In another embodiment, the restraint is an earthen berm.

In yet another embodiment, the pond further comprises a layer of Geo-technical fabric underneath the leakproof liner.

In still a further embodiment, the pond further comprises additional structural features.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a perspective view engineering diagram that illustrates an embodiment of a pond according to principles of the invention.

FIG. 1B is a perspective view engineering diagram of a corner of the pond illustrated in FIG. 1A, showing the details of construction in partial cutaway.

FIG. 2A is a perspective view engineering diagram that illustrates an embodiment of a pond having additional structural features within the area of the pond according to principles of the invention.

FIG. 2B is a perspective view engineering diagram that illustrates the relationship of the tie grid to elements of a pond having additional structural features according to principles of the invention.

FIG. 3A is a plan view engineering diagram that illustrates details of the assembly of a pond according to principles of the invention.

FIG. 3B is an elevation view engineering diagram along the direction A-A of FIG. 3 that illustrates details of the assembly of a pond according to principles of the invention.

FIG. 3C is an end view elevation engineering diagram that illustrates details of the assembly of a pond according to principles of the invention.

FIG. 3D is an elevation view engineering diagram along the direction B-B of FIG. 3 that illustrates details of the assembly of a pond according to principles of the invention.

FIG. 4A is a plan view engineering diagram that illustrates embodiments of pond curb elements having recesses to accommodate construction elements according to principles of the invention.

FIG. 4B is a perspective view engineering diagram that illustrates embodiments of pond curb elements shown in FIG. 4A having recesses to accommodate construction elements according to principles of the invention.

FIG. 4C is an elevation view engineering diagram as viewed from the exterior of a pond that illustrates embodiments of pond curb elements shown in FIG. 4A having recesses to accommodate construction elements according to principles of the invention.

FIG. 4D is a cross section view engineering diagram that illustrates embodiments of pond curb elements shown in FIG. 4A having recesses to accommodate construction elements according to principles of the invention.

FIG. 5A, FIG. 5B, FIG. 5C and FIG. 5D are perspective view engineering drawings that illustrate embodiments of wall or curb elements according to principles of the invention.

FIG. 6A is a plan view engineering diagram that illustrates embodiments of pond curb elements and elements used to connect the pond curb elements of a pond according to principles of the invention.

FIG. 6B is a perspective view engineering diagram that illustrates embodiments of pond curb elements shown in FIG. 6A according to principles of the invention.

FIG. 6C is an elevation view engineering diagram as viewed from the exterior of a pond that illustrates embodiments of pond curb elements shown in FIG. 6A according to principles of the invention.

FIG. 6D is a cross section view engineering diagram that illustrates embodiments of pond curb elements shown in FIG. 6A according to principles of the invention.

FIG. 7A, FIG. 7B, FIG. 7C, FIG. 7D, FIG. 7E, FIG. 7F and FIG. 7G are perspective view engineering diagrams that illustrate various embodiments of wall elements of a pond according to principles of the invention.

FIG. 8A, FIG. 8B, FIG. 8C and FIG. 8D are perspective view engineering diagrams that illustrate various examples of joints in a wall of a pond according to principles of the invention.

FIG. 9A is a perspective view of another embodiment of a construction method.

FIG. 9B is a vertical section view of the construction method illustrated in FIG. 9A.

FIG. 9C is a cross section view along the direction B-B indicated in FIG. 9B.

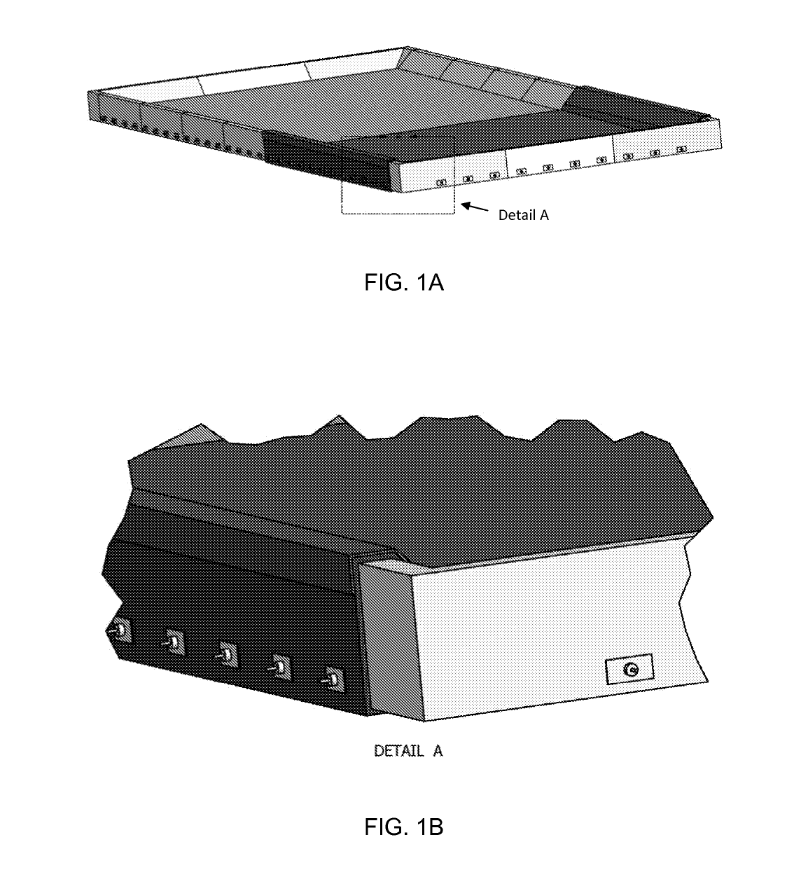

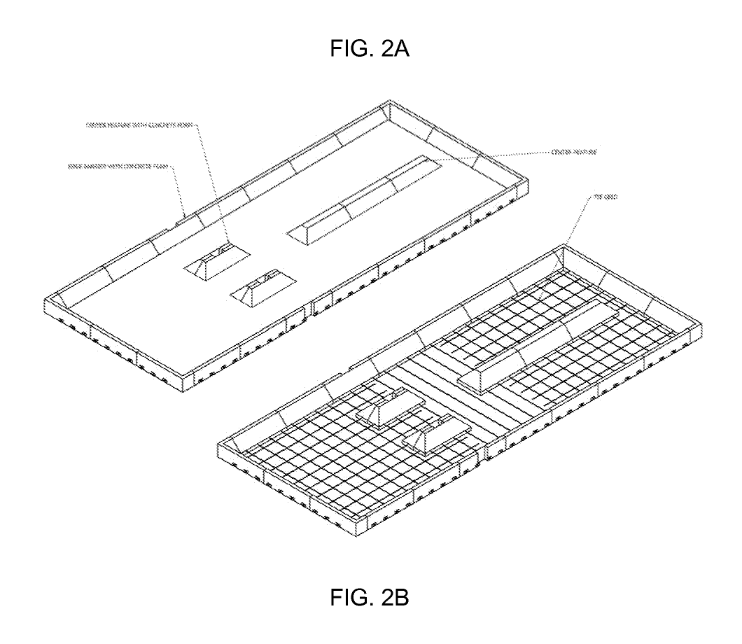

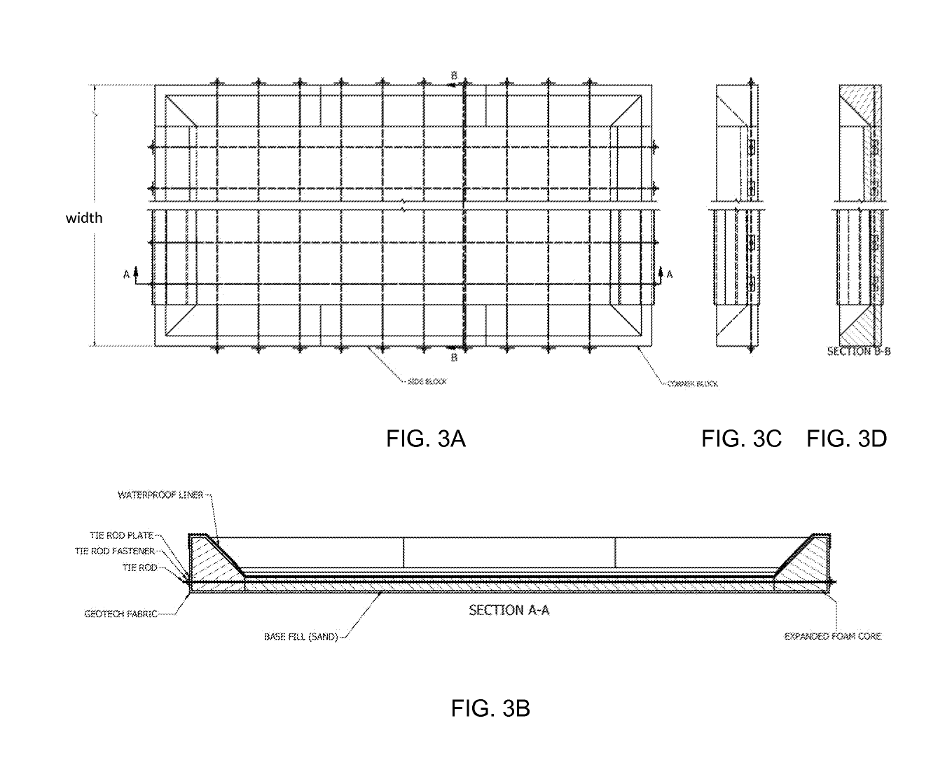

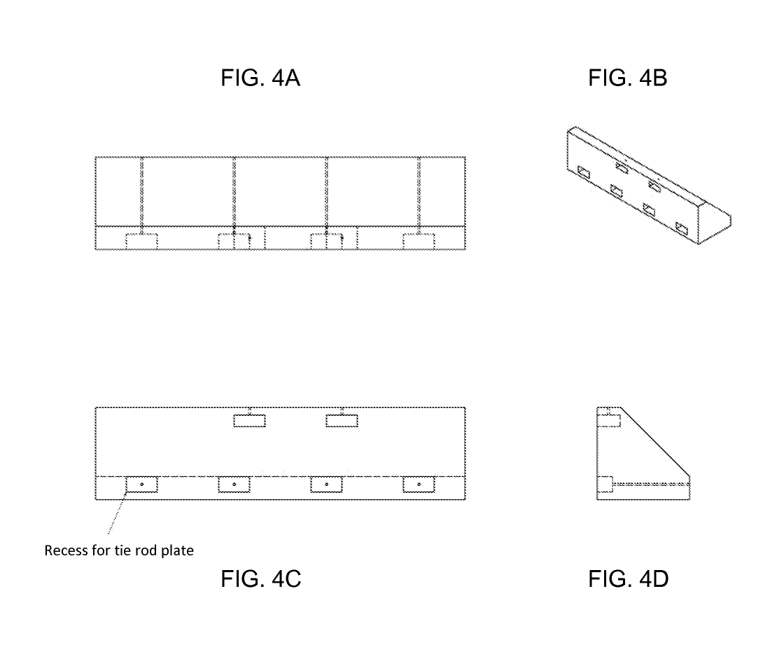

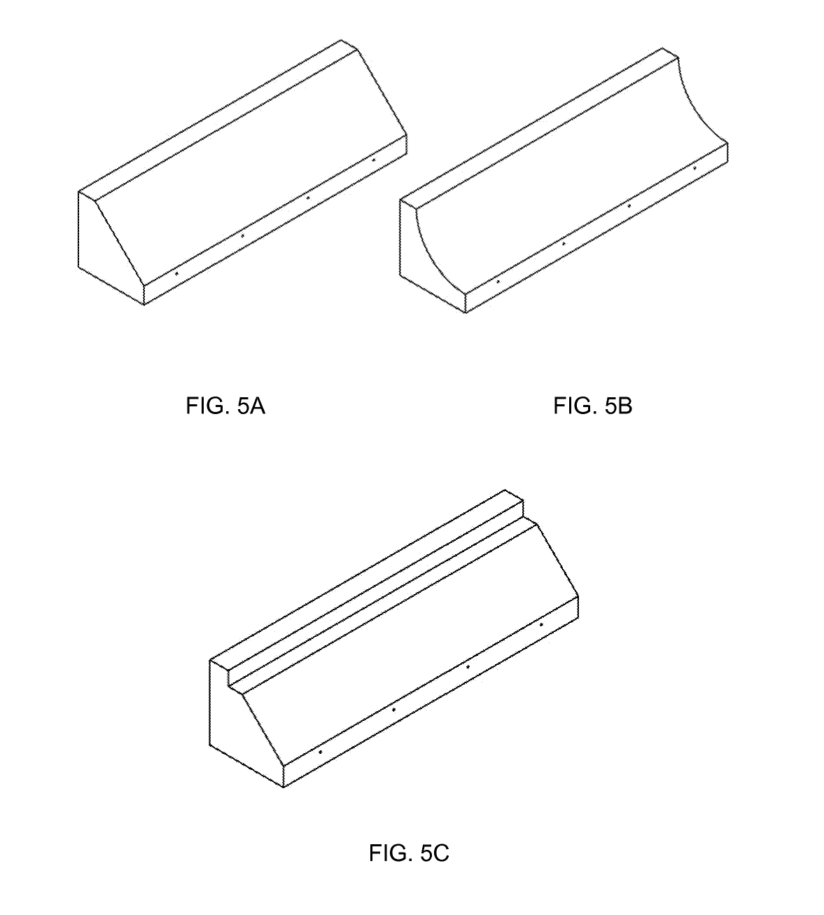

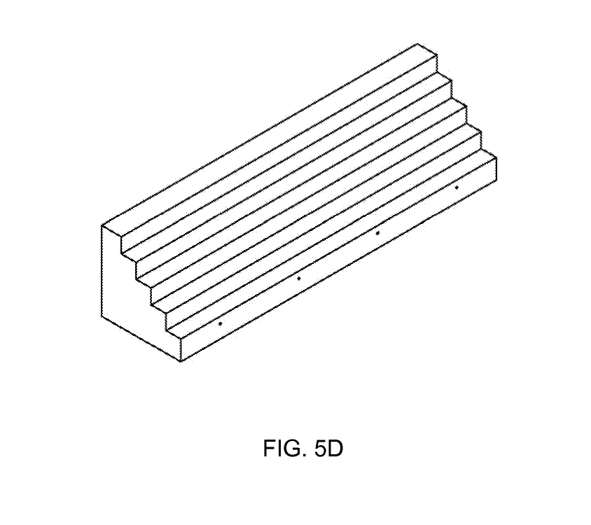

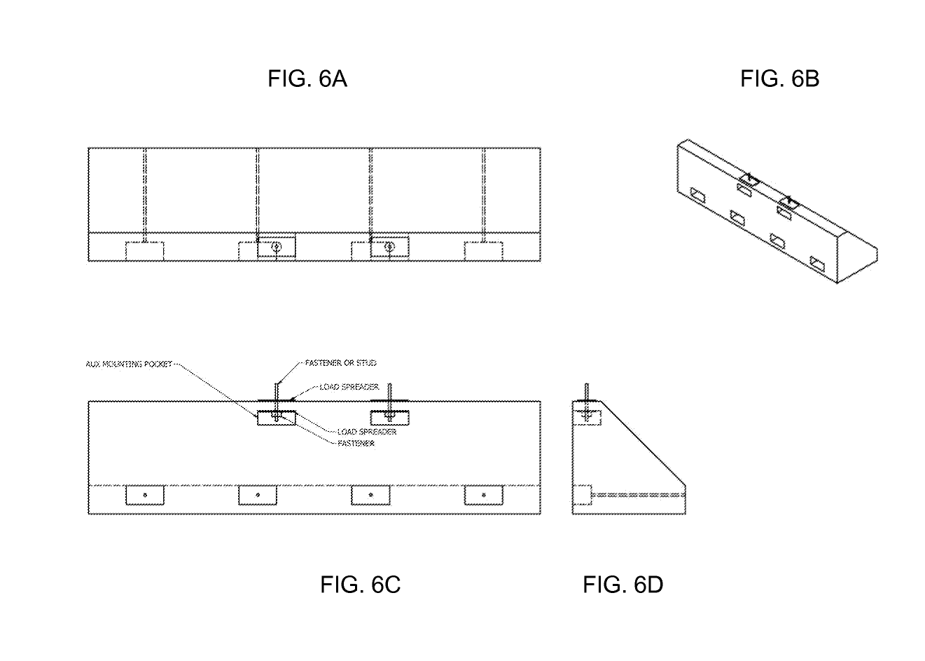

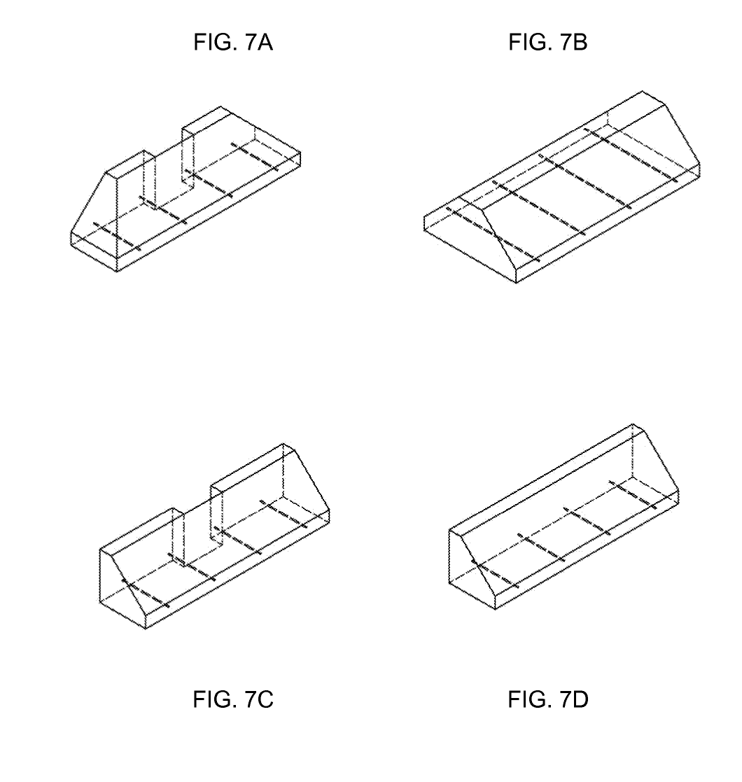

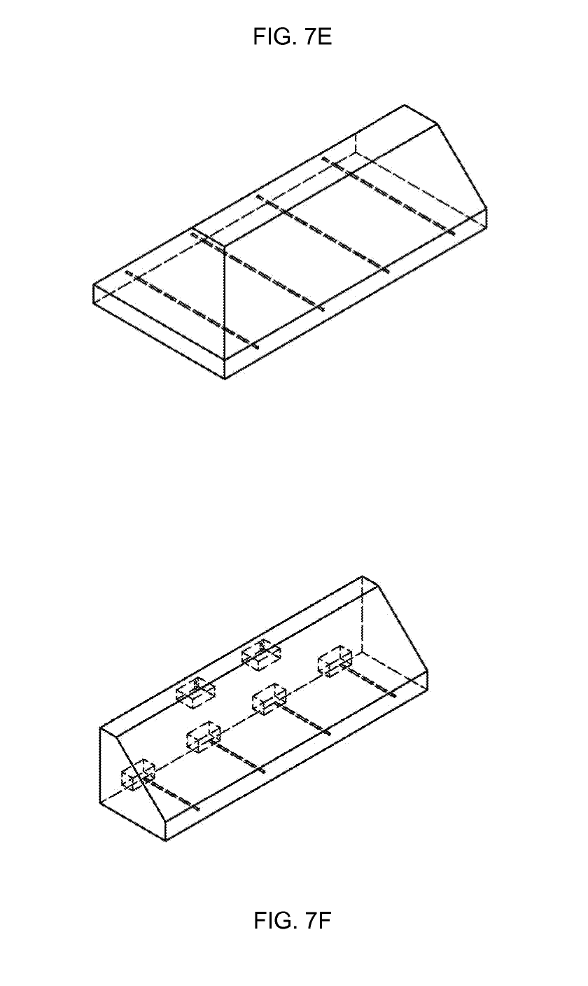

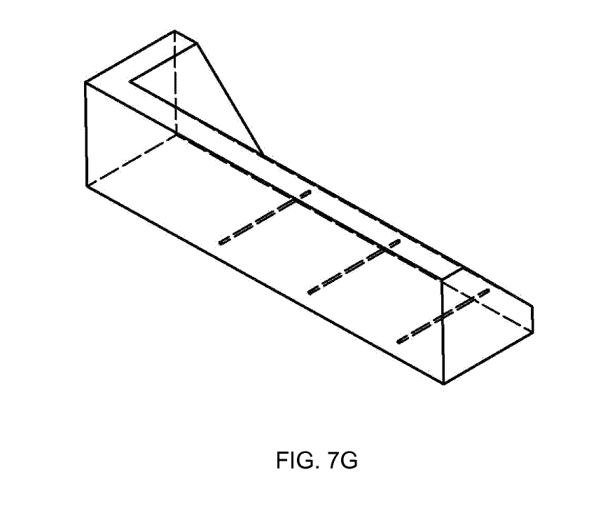

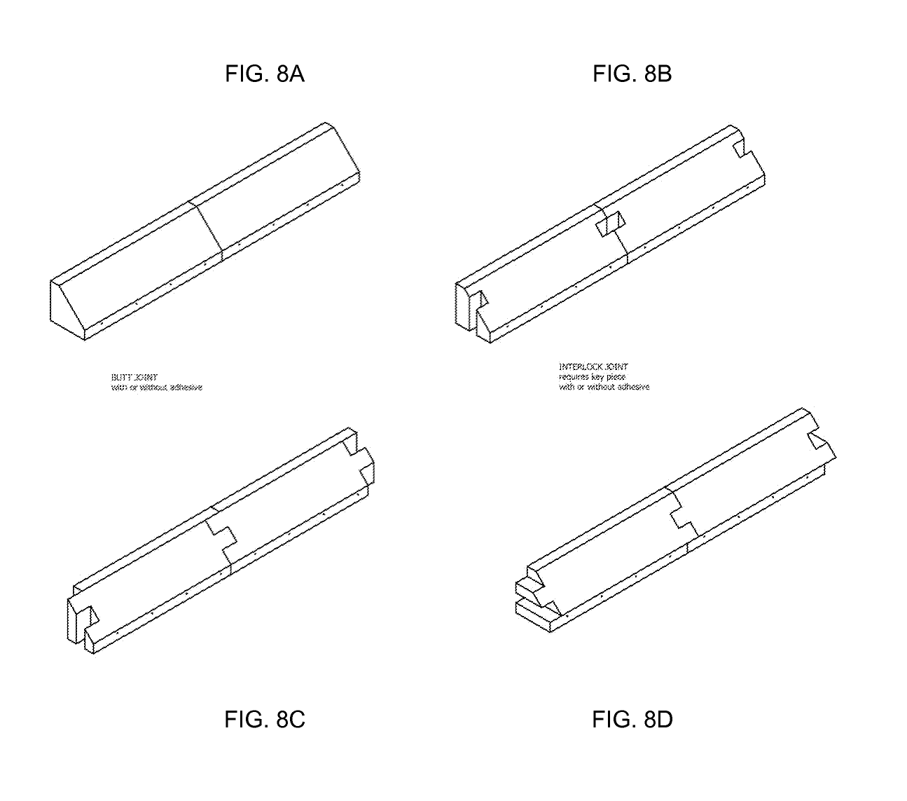

### DETAILED DESCRIPTION

The invention relates to the structure, and method of manufacture of shallow ponds that are useful for such activities as aquaculture, renewable energy harvesting by growing plants such as algae, and fish farming. Another possible use is as a bathing pond or swimming pool. Other uses will become apparent as the invention is further understood.

The pond described herein can be constructed with various dimensions. In one embodiment, the dimensions are 10 meters wide by 180 meters long by approximately one meter high. For other designs, the width, the length and the depth can be adjusted as needed.

The pond described herein below is supported on an area defined on a layer of base fill, which preferably can be sand or other material. The base fill may be graded or smoothed to provide a substantially planar surface.

The pond comprises the following components:

A Geo-technical (or “Geo-tech”) fabric is provided to cover the area that the pond will occupy, with some additional fabric that is used to wrap the sides of the erected pond. The Geo-technical fabric keeps the base fill from being washed out from under the pond. In addition, when wrapped over the sides of the erected pond, it provides additional restraint to keep the walls in place.

The walls of the pond are fabricated using expanded foam core rigid material or other low density material, which may be constructed of segments, that defines the dimensions of the pond and controls the basic shape of the pond walls. Fastening structures are provided which hold the expanded foam core rigid material segments in relative alignment to define pond dimensions. The fastening structures can include tie rods, tie rod plates and tie rod fasteners. In one embodiment, the tie rods have threads at least at their ends. They are placed through apertures defined in the expanded foam core rigid material with the threaded ends exposed. Tie rod plates are preferably placed over the exposed threaded ends and serve to spread the compressive load applied when the tie rod fasteners are threaded on to the threaded tie rod ends, so that the load is distributed and does not crush or damage the expanded foam core rigid material. The tie rods are of sufficient strength to support the tensile forces applied by the walls of the pond when it is filled with water, or with its intended contents.

A leakproof liner, comprising a sheet of PVC, or other plastic liner material, is used to contain the liquid, generally water, that is filled into the erected pond. In some embodiments, a layer of Geo-technical material can be place underneath the leakproof liner to protect it from the base fill.

### Method of Construction

The pond is constructed as follows:

The site where the pond will be erected is prepared by being leveled or graded, if necessary, so that it is approximately level and approximately flat. Material that is removed in leveling the site can be used for base fill.

A Geo-technical fabric is installed, or laid down where the pond is to be constructed.

Segments of expanded foam core are installed to define the size and shape of the pond. The expanded foam core segments are laid out to form a level basin. Optionally the bases of the expanded foam core segments can be shaped to correct for grade. Optionally the sides of the expanded foam core segments can be shaped to control pond shape.

The Geo-tech fabric is wrapped up around the expanded foam core segments and down the inside slope of the periphery of the pond defined by the expanded foam core segments.

The tie rods, tie rod plates, and fasteners are installed. The tie rods are inserted through the expanded foam core segments. The tie rod plates are fitted over the threaded ends of the tie rods. The tie rod fasteners are installed. While the tie rods and tie rod fasteners are described herein as being threaded, any convenient attaching method can be used, such as the use of compression fittings, adhesives, cements, or swage fittings.

Base fill material is installed within the pond area defined by the expanded foam core segments. The base fill can be site material, sand, or other suitable fill. The base fill material can be compacted and can be designed to have a grade or tilt relative to a local vertical direction defined with respect to a gravitational field. The grade or tilt optionally can be provided to assist a flow of liquid in the pond.

A Geo-tech fabric is installed over the base fill if necessary. The Geo-tech fabric can be a separate sheet of Geo-tech fabric from the one laid under the pond, or it can be the extremities of the Geo-tech fabric laid under the pond.

As required or as desired, additional backfill can be installed around the exterior sides of the expanded foam core segments.

A waterproof liner, comprising a sheet of PVC, or other plastic liner material, is installed inside the pond to provide a volume that holds water. The waterproof liner is preferably fixed or anchored to the walls of the pond defined by the expanded foam core segments.

The pond can include additional structural features such as walkways and/or a divider that divides a pond into two or more regions. These structures can be constructed from expanded foam core segments. They can be installed as free-standing structures or they can be installed between two expanded foam core walls. These additional features allow, e.g., for circulating flow.

In addition, the principles of the invention can be used to provide expanded foam core structures that will support multiple ponds close together. In one embodiment, recesses are provided that allow the tie rod plates and fasteners to be recessed into the “exterior” surface of a wall constructed of expanded foam core segments, so that two walls can be installed “back-to-back.”

The pond can also include integrated equipment supports and piers, and features for installing pumps and tubes or other structures for moving material into and out of the pond.

When completed, the pond is filled with a fluid of interest, which in many applications is water. The fluid can include materials added to adapt the fluid to an intended use, such as adding chlorine to water in a swimming pond, adding nutrients to water in a hydroponic growth pond, or adding salt to a pond intended to be used to collect solar thermal energy to provide a density gradient that is intended to mitigate convection within the fluid in the pond.

Some of the advantages of using expanded foam core segments are that they are able to be cut on-site to match a grade using a simple survey; they are lightweight and can be set without heavy equipment; they are durable (currently expanded foam is used as fill); and they are recyclable (e.g., the expanded foam core segments could possibly be recycled if system was dismantled).

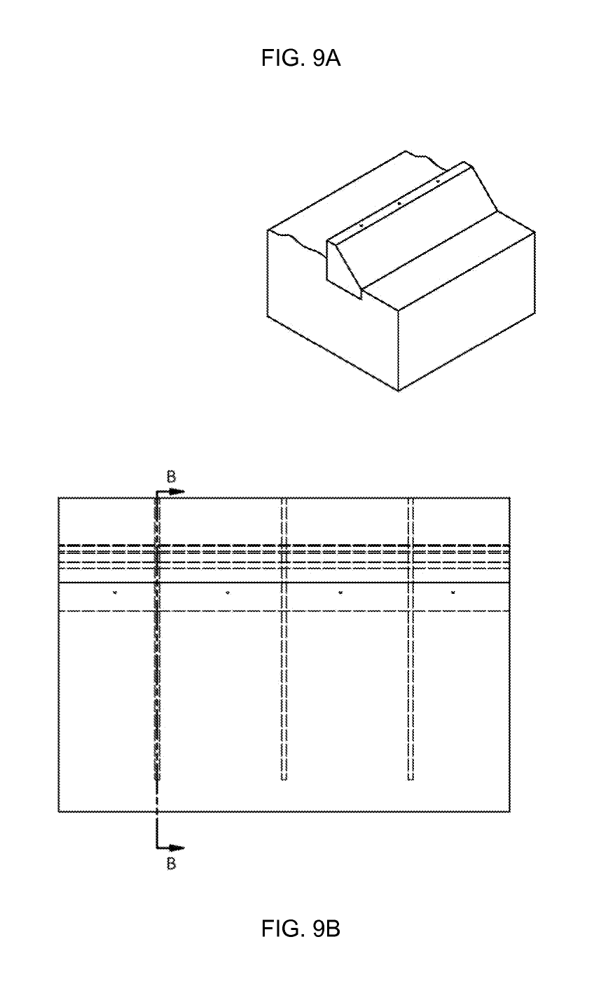

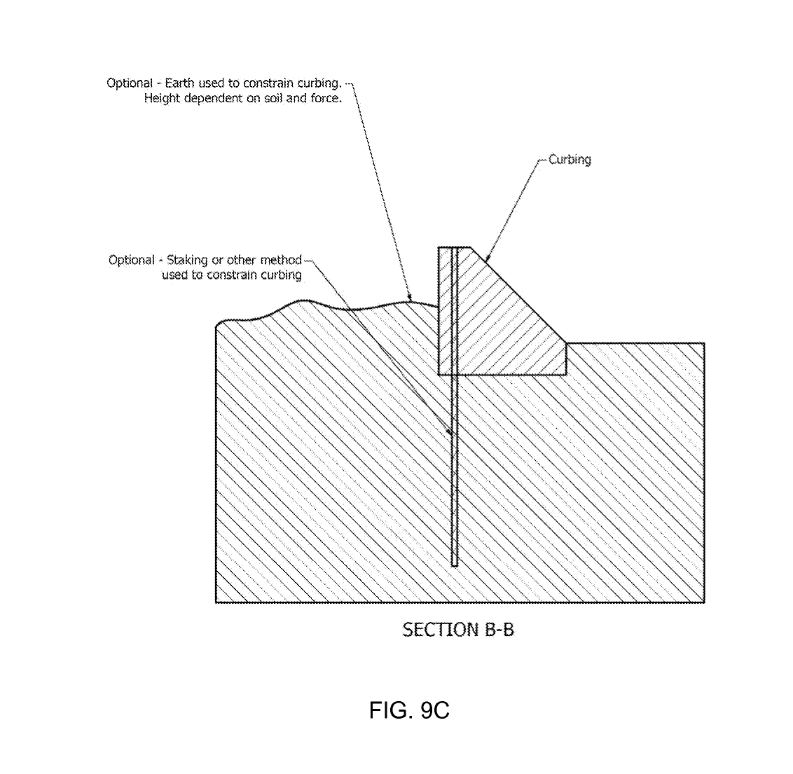

As illustrated in FIG. 9A, in an alternative embodiment, the expanded foam core can be held in place by the resistance of fill material or earth placed on either side thereof. For example, a trench can be provided, covered with the Geo-technical fabric, and then the expanded foam core sidewall is placed into the trench and the Geo-technical fabric is wrapped over it. Fill material, for example, earth, is then placed on the outer side of the wall formed by the expanded foam core material.

FIG. 9B is a vertical section view of the construction method illustrated in FIG. 9A.

FIG. 9C is a cross section view along the direction B-B indicated in FIG. 9B. As is illustrated in FIG. 9C, support optionally can be provided by earth used to constrain the motion of the expanded foam core wall or curbing. As is illustrated in FIG. 9C, support optionally can be provided by staking used to constrain the motion of the expanded foam core wall or curbing.

The construction method illustrated in FIG. 9A, FIG. 9B and FIG. 9C is an alternate embodiment to the use of cross ties. In the alternate embodiment, the curb can be restrained from moving by structures including but not limited to an earthen berm, direct burial of an end of the curb in a trench, the use of staking through the curb into the underlying earth, and use of the containing membrane itself for support.

It should be understood that different curb elements can be restrained using different methods in a single pond. For example, in a single pond, some curb elements might be held in their respective positions by using ties and fasteners, others might be restrained using earth or fill, and still others might be retrained by using stakes.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method of fabricating a pond, comprising the steps of:
installing a first Geo-technical fabric having an area, a periphery and a surface at a location where a pond is being constructed;
installing a plurality of segments of expanded foam core in respective positions with regard to one another, said plurality of segments of expanded foam core comprising a wall that defines a periphery of said pond, a size of said pond and a shape of said pond, a bottom surface of each of said plurality of segments of expanded foam core resting on said surface of said first Geo-technical fabric;
wrapping said periphery of said first Geo-technical fabric over and around an exterior surface of said plurality of segments of expanded foam core and down an inside surface of said periphery of said pond defined by said plurality of segments of expanded foam core;
providing a restraint that is configured to maintain each of said plurality of segments of expanded foam core in said respective positions; and
installing a leakproof liner inside said pond to provide a volume that holds a liquid.

2. The method of fabricating a pond of claim 1, further comprising the step of filling said pond with said liquid.

3. The method of fabricating a pond of claim 1, further comprising the step of, prior to the step of installing said first Geo-technical fabric, preparing said location where said pond is to be constructed.

4. The method of fabricating a pond of claim 1, further comprising the step of shaping said bottom surface of at least one of said plurality of segments of expanded foam core to correct for grade.

5. The method of fabricating a pond of claim 1, wherein the step of providing a restraint comprises providing tie rods and fasteners to maintain at least one of said plurality of segments of expanded foam core in its respective position.

6. The method of fabricating a pond of claim 1, wherein the step of providing a restraint comprises providing fill material to maintain at least one of said plurality of segments of expanded foam core in its respective position.

7. The method of fabricating a pond of claim 1, wherein the step of providing a restraint comprises placing said bottom surface of at least one of said plurality of segments of expanded foam core in a trench to maintain said at least one of said plurality of segments of expanded foam core in its respective position.

8. The method of fabricating a pond of claim 1, further comprising the step of arranging material to define a grade of a bottom of said pond prior to installing said leakproof liner.

9. The method of fabricating a pond of claim 8, further comprising the step of installing a layer of Geo-technical fabric over said bottom of said pond prior to installing said leakproof liner.

10. The method of fabricating a pond of claim 9, wherein said layer of Geo-technical fabric is part of said first Geo-technical fabric.

11. The method of fabricating a pond of claim 9, wherein said layer of Geo-technical fabric is not part of said first Geo-technical fabric.

12. The method of fabricating a pond of claim 1, wherein said leakproof liner is anchored to a wall of said pond.

13. The method of fabricating a pond of claim 1, further comprising the step of providing one or more additional structural features.

14. A pond, comprising:
a first Geo-technical fabric having an area, a periphery and a surface situated at a location;
a plurality of segments of expanded foam core in respective positions with regard to one another, said plurality of segments of expanded foam core comprising a wall that defines a periphery of said pond, a size of said pond and a shape of said pond, a bottom surface of each of said plurality of segments of expanded foam core resting on said surface of said first Geo-technical fabric, said periphery of said first Geo-technical fabric overlayed about an exterior surface of said plurality of segments of expanded foam core and placed down an inside surface of said periphery of said pond defined by said plurality of segments of expanded foam core;
a restraint that is configured to maintain each of said plurality of segments of expanded foam core in said respective positions; and
a leakproof liner inside said pond to provide a volume that holds a liquid;
said pond configured to be disassembled and removed from said location when no longer required, said disassembly and removal capable of being performed in an environmentally-friendly manner.

15. The pond of claim 14, wherein said restraint is a tie rod and at least one fastener.

16. The pond of claim 14, wherein said restraint is an earthen berm.

17. The pond of claim 14, wherein said pond further comprises a layer of Geo-technical fabric underneath said leakproof liner.

18. The pond of claim 14, wherein said pond further comprises additional structural features.
